(19) United States
(12) Patent Application Publication
(10) Pub. No.: US 2025/0019115 A1
(43) Pub. Date: Jan. 16, 2025

(54) RECEPTACLE FOR A DENTAL BLANK

(71) Applicant: Ivoclar Vivadent AG, Schaan (LI)

(72) Inventors: Jens HEINEN, Sevelen (CH); Saskia KÜBLER, Buchs (CH)

(21) Appl. No.: 18/765,510

(22) Filed: Jul. 8, 2024

(30) Foreign Application Priority Data
Jul. 10, 2023 (EP) 23184433.3

(51) Int. Cl. B65D 5/50; A61C 13/00; B65B 5/04

(52) U.S. Cl. CPC B65D 5/5038; A61C 13/0022; B65B 5/04

(57) ABSTRACT

A receptacle (100) for a dental blank (103), having a recess (105) for inserting the dental blank (103); and a projecting clamping lug (107) for clamping the blank (103), which protrudes into the recess (105).

### CROSS-REFERENCE TO RELATED APPLICATIONS

This application claims priority to European Patent Application No. 23184433.3 filed on Jul. 10, 2023, the disclosure of which is incorporated herein by reference in its entirety.

### TECHNICAL FIELD

The present invention relates to a receptacle for a dental blank and a method for accommodating a dental blank.

### SUMMARY

It is the technical task of the present invention to safely store and ship a dental blank.

This task is solved by the subject matter according to the independent claims. Technically advantageous embodiments are the subject matter of the dependent claims, the description and the drawings.

According to a first aspect, this technical task is solved by a receptacle for a dental blank, with a recess for inserting the blank; and a projecting clamping lug for clamping the blank, which projects into the recess. This provides the technical advantage, for example, that dental blanks can be stored safely for transportation and storage.

In a technically advantageous embodiment of the receptacle, the receptacle comprises two protruding clamping lugs. This provides the technical advantage, for example, that the dental blank is better supported in the recess.

In a further technically advantageous embodiment of the receptacle, the two clamping lugs are arranged on one side of the recess. This provides the technical advantage, for example, that the dental blank is fixed by means of two support points.

In a further technically advantageous embodiment of the receptacle, the two clamping lugs are arranged on opposite sides of the recess. This provides the technical advantage, for example, that the fixation of the dental blank in the receptacle is further improved.

In a further technically advantageous embodiment of the receptacle, the recess has a rectangular cross-section. This provides the technical advantage, for example, that block-shaped dental blanks can be accommodated.

In a further technically advantageous embodiment of the receptacle, the recess comprises a resilient bottom. This provides the technical advantage, for example, that damage to the dental blank can be further reduced.

In a further technically advantageous embodiment of the receptacle, the receptacle comprises a removable lid. This provides the technical advantage, for example, that the dental blank can be removed in an easy manner.

In a further technically advantageous embodiment of the receptacle, the clamping lug is formed by a rounded projection. This provides the technical advantage, for example, that a safe frictional connection is achieved between the receptacle and the dental blank.

In a further technically advantageous embodiment of the receptacle, the recess comprises a section for inserting a retaining section of the blank. This provides the technical advantage, for example, that blanks with a mechanical milling interface can also be accommodated as a retaining device.

In a further technically advantageous embodiment of the receptacle, the recess is formed in a cardboard. This provides the technical advantage, for example, that the receptacle can be manufactured with little effort.

In a further technically advantageous embodiment of the receptacle, the cardboard can be inserted into the receptacle. This provides the technical advantage, for example, that different cardboards with different recesses can be inserted.

In a further technically advantageous embodiment of the receptacle, the cardboard comprises a spacer section for supporting the cardboard within the receptacle. This provides the technical advantage, for example, that the storage of the dental blank is further improved.

In a further technically advantageous embodiment of the receptacle, the clamping lug is formed by the cardboard. This provides the technical advantage, for example, that the clamping lug can be formed in an easy manner by punching out.

In a further technically advantageous embodiment of the receptacle, the cardboard forms a bottom onto which the dental blank is placeable. This provides the technical advantage, for example, that the dental blank is supported at the rear.

According to a second aspect, this technical problem is solved by a method for accommodating a dental blank, comprising the steps of inserting the blank into a recess; and clamping the blank in the recess by means of a projecting clamping lug. The method provides the same technical advantages as the receptacle according to the first aspect.

### BRIEF DESCRIPTION OF THE DRAWINGS

Exemplary embodiments of the invention are shown in the drawings and are described in more detail below, in which:

FIG. 1 shows a schematic view of a receptacle without a dental blank;

FIG. 2 shows a schematic view of the receptacle with a dental blank;

FIG. 3 shows a perspective view of the receptacle with several dental blanks;

FIG. 4 shows a technical drawing of a cardboard for manufacturing the receptacle;

FIG. 5 shows a technical drawing of a further cardboard for manufacturing the receptacle;

FIG. 6 shows a technical drawing of a further cardboard for manufacturing the receptacle; and

FIG. 7 shows a block diagram for accommodating a dental blank.

### DETAILED DESCRIPTION

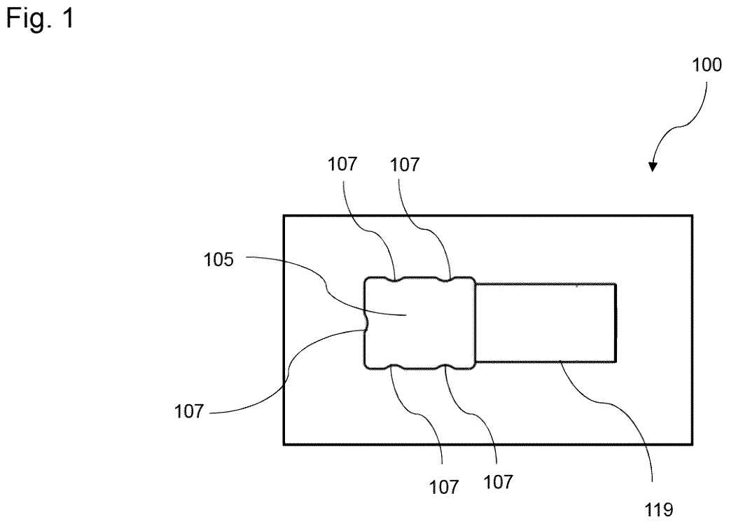

FIG. 1 shows a schematic view of a receptacle 100 without an inserted dental blank. The receptacle 100 comprises a recess 105 for inserting the blank. The recess comprises five projecting clamping lugs 107 for clamping the blank, which protrude laterally into the recess 105.

Two clamping lugs 107 are arranged on one side of the recess 105 and two clamping lugs 107 are arranged on the other side of the recess. By means of the oppositely arranged clamping lugs 107, the dental blank can be held securely in the recess 105 so that it does not fall out even when the receptacle 100 is turned over. The recess 105 comprises a section 119 in which a retaining section of the dental blank can be arranged. However, the clamping lugs 107 are located in the area in which the dental blank has a block-shaped body.

The container 100 is used to protect the dental blank during transportation and for storage. The receptacle 100 enables a material-universal locking by means of holding points in the area of the recess 105. A block tolerance of the dental blanks is compensated by the flexible clamping lugs 107 as holding points. The clamping lugs 107 stabilize the dental blank in the central position by means of retaining tabs. Nevertheless, the dental blank can be removed by hand by a user.

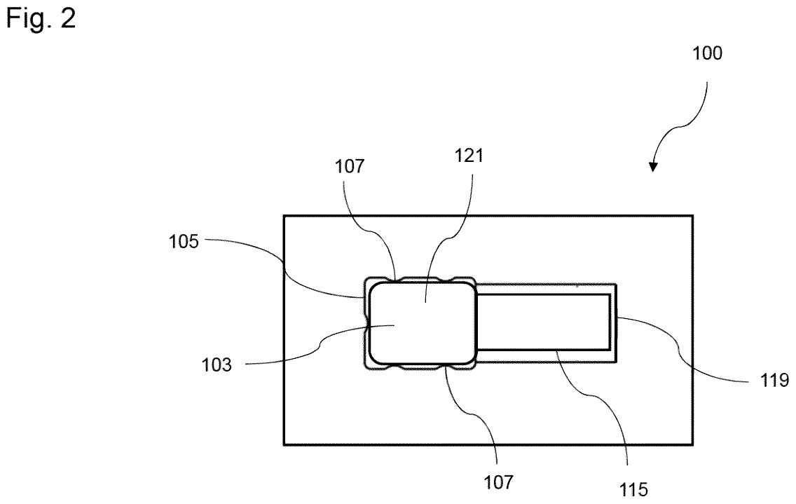

FIG. 2 shows a schematic view of the receptacle 100 with inserted dental blank 103. The dental blank 103 comprises a block-shaped body 121 for dental applications and a retaining section 115, with the help of which the blank 103 is clamped and held in a milling machine. The body 121 for dental applications can be, for example, a ceramic body, a plastic body or a zirconium oxide body. The retaining section 115 of the dental blank 103 is received in the portion 119 of the recess 105. The dental blank 103 has dimensions of, for example, 18 mm×14.5 mm×14.5 mm. The receptacle 100 can be made entirely of cardboard or fiber (mono-packaging). In this case, the receptacle 100 can be recycled in a simple manner.

The recess 105 is dimensioned so that the dental blank 103 can be inserted into it. When the dental blank is inserted, it is held in position in the recess 105 by the clamping lugs 107. Unintentional falling out or slipping of the dental blank 103 can thus be prevented.

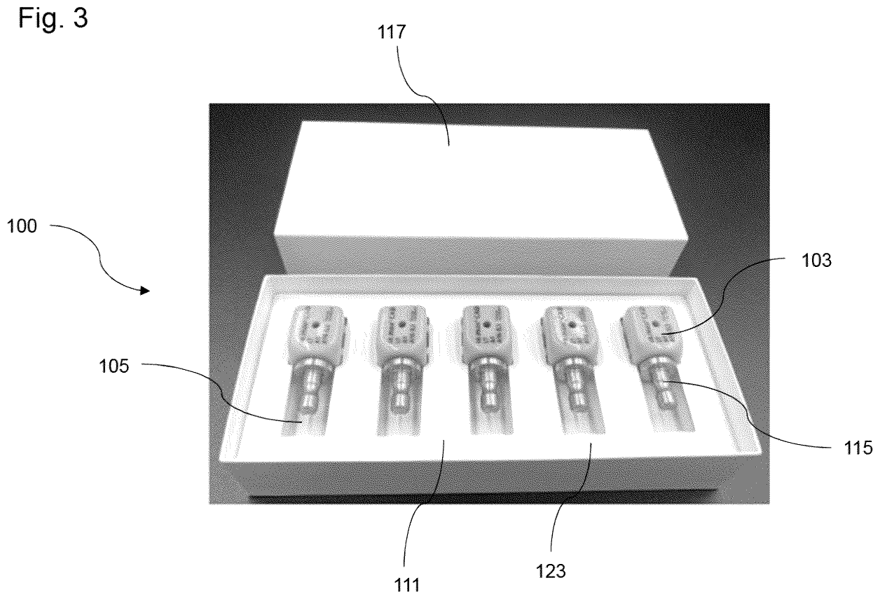

FIG. 3 shows a perspective view of the box-shaped receptacle 100 with several dental blanks 103. The receptacle 100 is formed from a cardboard 111 and comprises a removable lid 117. The adoption of the block shape can take place in the punching contour. The recesses 105 are formed in an insert 123 made of cardboard 111.

The receptacle 100 shown comprises five adjacent recesses 105, into each of which a dental blank 103 is inserted. In general, however, the number, size and orientation of the recesses 105 can vary. In general, the size of the receptacle 100 may also vary.

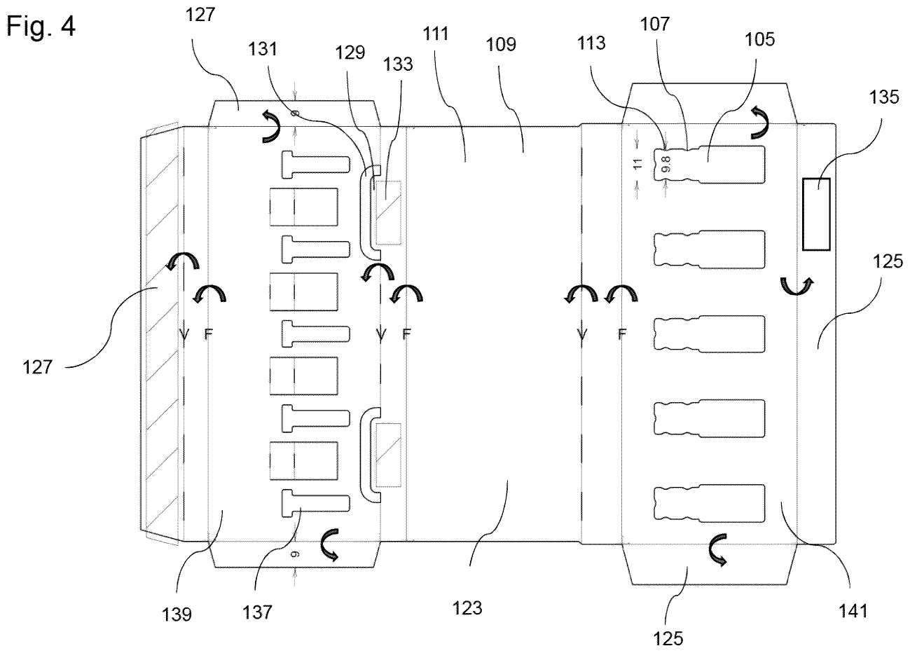

FIG. 4 shows a technical drawing of a cardboard 111 for the receptacle 100. The cardboard 111 has a thickness of 350 g/m², for example, and forms an insert 123 for the box-shaped receptacle 100. The recesses 105 are punched out of the cardboard 111 in the intended size. The cardboard 111 is pre-broken at the lines marked V and folded at the lines marked F. In the pre-broken, folded and glued state, the cardboard 111 can be inserted into the receptacle 100 and is supported by the side walls of the receptacle 100.

The side tabs 125 are folded backwards and the bottom 109 is folded inwards so that it is parallel to the top layer 141. The intermediate layer 139 is slid between the bottom 109 and the top layer 141. In the folded state, the intermediate layer 139 is located between the bottom 109 and the top layer 141, in which the recesses 105 for the dental blanks 103 are formed.

The clamping lugs 107 of the recesses 105 are formed by tabs, which form round projections 113 and protrude laterally into the recess 105. The clamping lugs 107 can protrude 0.6 mm, for example, so that an 11 mm wide recess 105 is narrowed to 9.8 mm on both sides by the clamping lugs 107. This allows, for example, a 10.5 mm wide dental blank 103 to be accommodated in the recess 105 without it unintentionally falling out or slipping.

In the folded state, the recesses 105 are formed in one plane of the cardboard 111 and the bottom 109 is formed in another plane of the cardboard 111. The intermediate layer 139, which is also formed by a section of the cardboard 111, is located between these two planes. The intermediate layer 139 forms a support surface onto which the inserted dental blank 103 is placeable. The intermediate layer 139 also comprises further T-shaped recesses 137, into which the retaining sections 115 with a larger diameter subside. The intermediate layer 139 prevents the dental blank 103 from subsiding too deeply into the recess 105 and holds the dental blank 103 in the center of the folded cardboard 111.

The bottom 109 is also spaced from the intermediate layer 139 and the top layer 141 by the spacer sections 129. The spacer sections 129 mutually stabilize the plane of the bottom 109, the intermediate layer 139 and the top layer 141.

For this purpose, the spacer sections 129 are folded vertically forwards. In the folded state, the projecting edge of the spacer sections 129 abuts against the inner surface of the top layer 141. The side tabs 127 are folded vertically backwards and support the bottom 109 at the edge. The side tabs 127 stabilize the intermediate layer 139 against the bottom 109.

Due to the intermediate layer 139, the dental blanks 103 are held at a distance from the bottom of the receptacle 100 so that they are arranged in the center of the receptacle 100. This prevents damage during transportation.

The cutout 131 for the adhesive tab 133 is folded and glued to the topside of the insert. The adhesive tab 133 is folded down from the top and glued to the bottom layer at position 135. The adhesive tab 133 stabilizes the distance from the intermediate layer 139 to the bottom layer of the bottom 109.

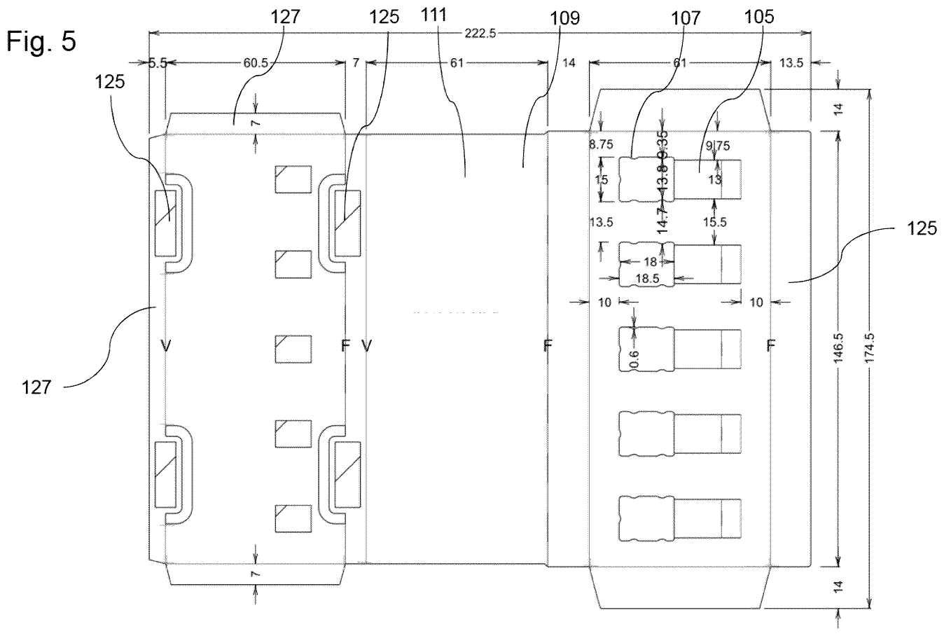

FIG. 5 shows a technical drawing of another cardboard 111 for manufacturing the receptacle 100 with dimension specifications in mm. The recesses 105 are shaped in such a way that they can accommodate other dental blanks 103. In its folded state, the receptacle 100 can have dimensions of 146.5 mm in length, 61 mm in width and 14 mm in height, for example. The clamping lugs 107 can protrude by 0.75 mm, for example, so that a 15 mm wide recess 105 is narrowed to 13.5 mm.

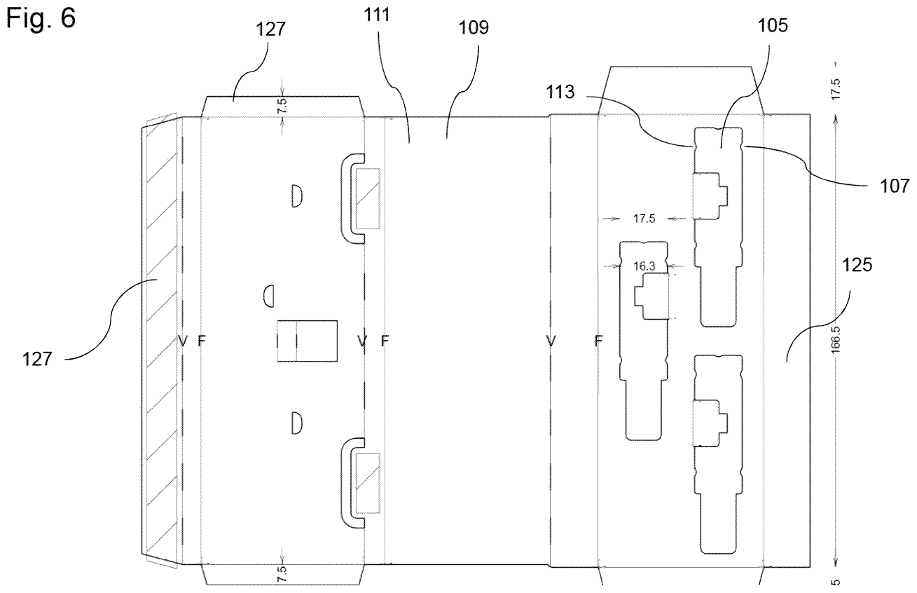

FIG. 6 shows a technical drawing of a further cardboard 111 for manufacturing the receptacle 100. The cardboard 111 has three recesses 105 for further dental blanks 103. The clamping lugs 107 can also protrude 0.6 mm, for example, and narrow a 17.5 mm wide recess 105 to 16.3 mm.

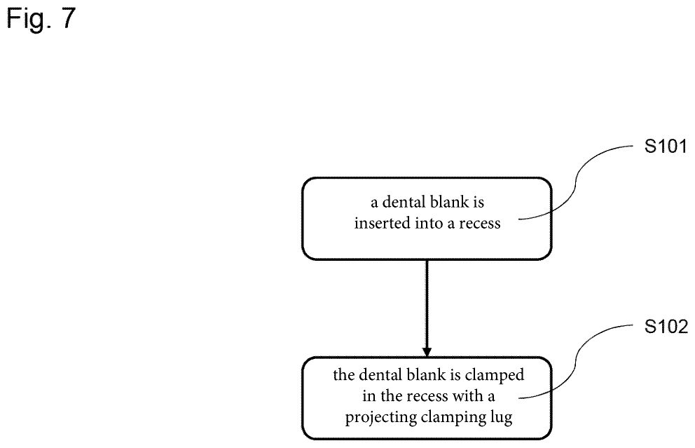

FIG. 7 shows a block diagram for accommodating a dental blank 103. In step S101, the dental blank 103 is inserted into a recess 105. In step S102, the dental blank 103 is inserted into the recess 105 having a protruding clamping lug 107. In this way, the dental blank 103 is retained safely in the recess 105 so that unintentional falling out is prevented.

All of the features explained and shown in connection with individual embodiments of the invention can be provided in different combinations in the subject matter according to the invention in order to simultaneously realize their advantageous effects.

All method steps can be implemented by devices that are suitable for executing the respective method step. All functions performed by the features of the subject matter can be a method step of a method.

The scope of protection of the present invention is given by the claims and is not limited by the features explained in the description or shown in the figures.

### REFERENCE LIST

100 Receptacle
103 Dental blank
105 Recess
107 Clamping lug
109 Bottom
111 Cardboard
113 Projection
115 Retaining section
117 Lid
119 Section
121 Body
123 Insert
125 Side tab
127 Side tab
129 Spacer portion
131 Cutout
133 Adhesive tab
135 Position
137 Recess
139 Intermediate layer
141 Top layer

1. A receptacle for a dental blank, comprising:
a recess for inserting the blank; and
a projecting clamping lug for clamping the blank, which protrudes into the recess.

2. The receptacle according to claim 1,
wherein the receptacle comprises two projecting clamping lugs.

3. The receptacle according to claim 2,
wherein the two clamping lugs are arranged on one side of the recess.

4. The receptacle according to claim 2,
wherein the two clamping lugs are arranged on opposite sides of the recess.

5. The receptacle according to claim 1,
wherein the recess has a rectangular cross-section.

6. The receptacle according to claim 1,
wherein the recess comprises a resilient bottom.

7. The receptacle according to claim 1,
wherein the receptacle comprises a removable lid.

8. The receptacle according to claim 1,
wherein the clamping lug is formed by a rounded projection.

9. The receptacle according to claim 1,
wherein the recess comprises a portion for inserting a retaining portion of the dental blank.

10. The receptacle according to claim 1,
wherein the recess is formed in cardboard.

11. The receptacle according to claim 10,
wherein the cardboard is insertable into the receptacle.

12. The receptacle according to claim 10,
wherein the cardboard comprises a spacer portion for supporting the cardboard within the receptacle.

13. The receptacle according to claim 10,
wherein the clamping lug is formed by the cardboard.

14. The receptacle according to claim 10,
wherein the cardboard forms a bottom onto which the dental blank is placeable.

15. A method for accommodating a dental blank, comprising the steps of:
inserting (S101) the blank into a recess; and
clamping (S102) the blank in the recess with a projecting clamping lug.
